(19) United States
(12) Patent Application Publication
(10) Pub. No.: US 2002/0049077 A1
(43) Pub. Date: Apr. 25, 2002

(54) Weather station

(76) Inventors: Gero Baese, Muenchen (DE); Andre Fischer, Berlin (DE); Peter Moritz, Haar (DE); Arnd Sibila, Moorenweis (DE); Juergen Wilde, Taufkirchen (DE); Georg Berner, Vaterstetten (DE); Martin Gebler, Pulach im Isartal (DE); Sabine Markgraf, Gauting (DE); Annette Scholssnikel, Muenchen (DE); Christian Von Brockdorff, Icking (DE); Stefan Prange, Muenchen (DE)

Correspondence Address: BELL, BOYD & LLOYD, LLC, P. O. BOX 1135, CHICAGO, IL, 60690-1135, US

(21) Appl. No.: 09/964,033

(22) Filed: Sep. 25, 2001

(30) Foreign Application Priority Data
Sep. 26, 2000 (DE) 100 47 609.0

(51) Int. Cl. H04M 1/00

(52) U.S. Cl. 455/561; 455/66

(57) ABSTRACT

A weather station which enables simple, efficient, low-cost recording of environmental data in that the recording is carried out with an environmental data recording device which is physically integrated with a base station of a mobile radio network.

### BACKGROUND OF THE INVENTION

The present invention relates to methods and devices for generating environmental data.

An object of the present invention is to produce a simple, efficient, low-cost recording of data relating to the environment of a device (hereinafter, referred to as environmental data).

### SUMMARY OF THE INVENTION

The present invention enables recording of location-dependent environmental data (differing at a number of locations) with a maximum recording density of the environmental data on the order of magnitude of the base station density of any given mobile radio network; such as a GSM or UMTS mobile radio network.

According to the present invention, integration of sensors for recording environmental data into the base station of a telecommunications network is carried out for this purpose. Environmental data are any given data relating to the environment of a device which records them; in particular, weather data, pollen information, air pollution data, etc. An environmental data recording device may include sensors; in particular, for air pressure and/or temperature and/or pollen densities and/or the UV index and/or ozone concentrations and/or wind strength.

For this purpose, a wide range of known sensors can be used including, for example, cameras.

A physically and/or functionally integrated arrangement according to the present invention of an environmental data recording device in, or connected on, a base station, in particular the connection to its connection infrastructure, may be particularly advantageous insofar as a power supply and data lines are already available in a base station and planning permission (on buildings, bridges, etc.) for erection of the base station has already been agreed between a mobile radio network operator and a building owner, etc.

In a simple and efficient manner, the present invention enables location-dependent generation by the base station(s) of a wide range of environmental data (location-dependent content production) which can be sold on immediately or after editing. The generated environmental data are directly available to the operator of a mobile radio network (and its base stations) for further use.

The tightly-meshed network of base stations of a mobile telecommunications network enables tightly-meshed environmental data recording in the area of a mobile telecommunications network.

The environmental data can be forwarded as content either immediately or following further processing (intelligent content processing); in particular, by the mobile radio network service provider. The data may be forwarded to terminal devices as a broadcast (forecast) to all or some subscribers in mobile radio cells or mobile radio cell groups, or point-to-point to mobile radio subscribers or to content service providers for further forwarding by the latter to terminal devices (of content buyers).

Particularly advantageous is the offering of a push service according to a customer profile for content purchasers; in particular, mobile radio subscribers with mobile radio terminal devices.

Additional features and advantages of the present invention are described in, and will be apparent from, the following Detailed Description of the Invention and the Figures.

### BRIEF DESCRIPTION OF THE FIGURES

FIG. 1 schematically shows environmental data recording according to the teachings of the present invention.

### DETAILED DESCRIPTION OF THE INVENTION

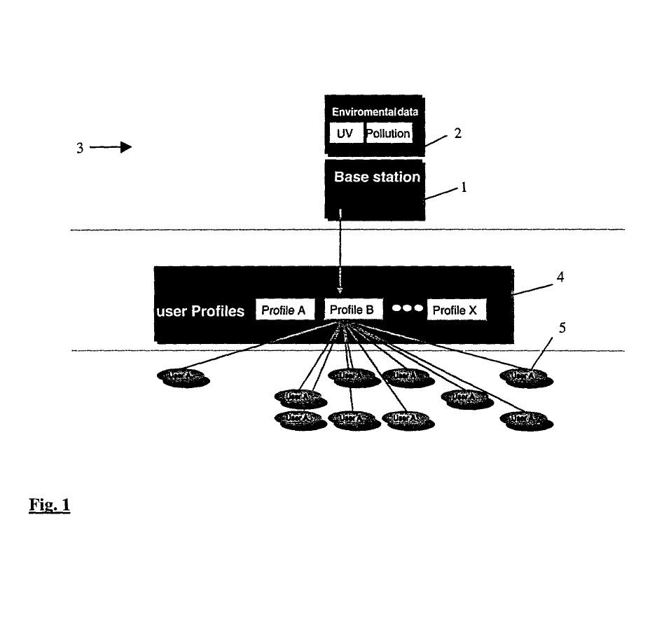

FIG. 1 shows a weather station disposed in a base station 1 of a mobile radio network 3, whose sensors 2 (here, by way of an example, UV sensors and air pollution sensors) record environmental data. These environmental data are forwarded to a service provider 4, e.g. the provider of the mobile radio network (in whose base stations the sensors are located) or a further service provider supplied by the latter with data. The further service provider forwards environmental data or data generated therefrom via the mobile radio network, the fixed network or the Internet (e.g., via html, wml, xml, etc.) to mobile radio terminal devices 5 (“User A” in FIG. 1) or other terminal devices of recipients (here, time-based, etc., according to their customer profile “Profile A” or “Profile B” or “Profile X”), at their request (pull), or unrequested (push, e.g. at times defined in the customer profile of a terminal device user, etc.).

Data may be transmitted to terminal devices point-to-point (e.g., via SMS PtP) or as a broadcast (e.g., as a cell broadcast, SMS-CB, etc.).

Although the present invention has been described with reference to specific embodiments, those of skill in the art will recognize that changes may be made thereto without departing from the spirit and scope of the invention as set forth in the hereafter appended claims.

1. A method for recording environmental data, the method comprising the steps of:
physically integrating an environmental data recording device with a base station of a mobile radio network; and
recording the environmental data via the environmental data recording device.

2. A method for recording environmental data as claimed in claim 1, wherein the environmental data recording device is at least partially disposed within the base station.

3. A method for recording environmental data as claimed in claim 1, the method further comprising the step of:
connecting sensors to the environmental data recording device via one of lines and radio, the sensors measuring data including at least one of air pollution data, pollen data, weather data, air pressure data, temperature data, UV index data and wind strength data.

4. A method for recording environmental data as claimed in claim 3, the method further comprising the step of:
forwarding the data, via one of the environmental data recording device and the sensors, to the base station via an interface which is respectively one of line-based and radio-based.

5. A method for recording environmental data as claimed in claim 1, the method further comprising the step of:
forwarding the recorded environmental data to a computer of a mobile radio network operator located outside a mobile station.

6. A method for recording environmental data as claimed in claim 1, the method further comprising the step of:
transmitting the recorded environmental data, according to a customer profile of at least one mobile radio subscriber, to at least one mobile radio subscriber in point-to-point or broadcast fashion.

7. An apparatus for recording environmental data relating to the environment of the apparatus, comprising:
sensors to record the environmental data; and
interfaces to transfer the environmental data from the sensors to a base station of a mobile telecommunications network in which the apparatus is disposed.

8. An apparatus for recording environmental data as claimed in claim 7, wherein the apparatus is physically integrated in the base station.

9. An apparatus for recording environmental data as claimed in claim 7, wherein the sensors sense at least one of air pollution data, pollen information data, weather data, air pressure data, temperature data, UV index data and wind strength data.

10. An apparatus for recording environmental data as claimed in claim 7, wherein at least one of the apparatus and the sensors are connected to at least one of a power supply of the base station and data lines to the base station.

11. A base station for a mobile telecommunications network, comprising an apparatus for recording environmental data relating to the environment of the apparatus, the apparatus being connected via interfaces to sensors which record the environmental data, such that the environmental data is transferred to the base station via the interfaces.
